(19) United States
(12) Patent Application Publication
(10) Pub. No.: US 2003/0046029 A1
(43) Pub. Date: Mar. 6, 2003

(54) Method for merging white box and black box testing

(76) Inventors: Jay Stuart Wiener, Clifton, VA (US); Robert Becka Calco, Centreville, VA (US)

Correspondence Address: Attn: Robert C. Curfiss, BRACEWELL & PATTERSON, L.L.P., P.O. Box 61389, Houston, TX, 77208-1389, US

(21) Appl. No.: 09/946,282

(22) Filed: Sep. 5, 2001

(51) Int. Cl. G06F 11/30; G06F 15/00; G21C 17/00

(52) U.S. Cl. 702/186

(57) ABSTRACT

A method and process for developing and testing software applies runtime executable patching technology to enhance the quality assurance effort across all phases of the Software Development Life-Cycle in a “grey box” methodology. The system facilitates the creation of re-usable, Plug‘n’Play Test Components, called Probe Libraries, that can be used again and again by testers as well as developers in unit and functional tests to add an extra safety net against the migration of low-level defects across Phases of the overall Software Development and Testing Life-Cycle. The new elements introduced in the Software Development Life-Cycle focus on bringing developers and testers together in the general quality assurance workflow and provide numerous tools, techniques and methods for making the technology both relatively easy to use and powerful for various test purposes.

### BACKGROUND OF THE INVENTION

1. Field of the Invention

The subject invention is generally related to techniques for verifying software applications and is specifically directed to methods incorporating white box and black box testing tools. More particularly, the invention is directed to a method for merging white box and black box testing. Specifically, the invention is directed to a method a process for facilitating collaboration between developers and testers in the process of debugging/testing an application under test (AUT), through the automated extension of white box test techniques (ordinarily the domain of developers only) to black box test methods (the domain of testers).

2. Discussion of the Prior Art

Prior art techniques for generating software programs and systems are characterized by a “split” between development and testing that is both organizational and technical in cause and effect. Lacking shared tools, techniques and methods of their respective trades, developers and testers seldom collaborate in any methodologically meaningful way in quality assurance. This has been a detriment of the state of the art in software engineering in general.

The prior art relied upon the developer to perform white box testing on his or her own code, usually taking advantage of integrated debuggers or special white box test tools to which only developers generally have access, but did not facilitate this practice in any unified fashion. When testers received code for test, after (it was assumed) initial developer debugging and testing was completed, it was usually already assembled into an integrated whole (or executable) whose internals were, so to speak, a “black box” to the testers. Testers had only the functional requirements or even less to work from in building their test scripts for functional and integration testing.

Testers did NOT have at their disposal any way to probe the internals of the application's behavior in a fashion that added value to the general test effort—i.e., for diagnostic and root cause analysis, or for obtaining meaningful metrics about their own test efforts, such as the percentage of code coverage provided by automated test scripts. Nor did they have any way to reuse unit tests that developers had already written against their own code when such tests might have come in handy for such purposes. Moreover, they had no way to cooperate with developers in obtaining meaningful defect-related data from the test or production environment. This created specific problems, particularly in convincing a developer that a defect existed, when such a defect was not easy to reproduce or only easy to reproduce in the test or production environment.

From the developer perspective, testers added little value to the debugging effort. The identification of problems and defects seldom contributed causal information or probative methods to help the developer solve the problems they uncovered. This built-in chasm in the life-cycle development and testing process created the perception—which became a reality—of a real “wall” between development and testing. It was not an uncommon feature of development culture in organizations to refer to releasing code to quality assurance as “throwing [code] over the wall”.

This communication breakdown required the developers to rely solely on their own ingenuity in recreating the problem in their own controlled debugging environments. Often this resulted in the developer reporting back to the tester that he or she was unable to reproduce the defect, and the tester would have to produce some more proof—a screenshot, crash dump information, or the like—to keep the defect open in the defect database, or prevent it from being categorized to a lower priority. The burden of proof was on the tester, but the means to provide such proof were primitive, to say the least. An adversarial, rather than collaborative, attitude between developers and testers was axiomatic due to the fact that they shared almost no common tools, techniques or methods in the performance of their respective roles.

For developers, an elusive defect meant another day of chasing leads in uncovering its root cause with little to go on but the tester's usually incomplete or partial description of the problem. But the developer's real challenge was in creating meaningful unit-level tests that prevent the elusive defect from ever migrating to the test environment in the first place. Generally, if a defect made it past the developer's unit testing, but was not detected or not consistently identifiable during general functional and integration testing, chances were that it would not be seen again—until the end-user suffered some negative consequence such as data loss, at which point the remedy of the defect is most costly to the vendor as well as to the customer.

To this end numerous “white box” test technologies (debuggers, code coverage analyzers, function profilers and tracers, and the like) were created. None of these resulted in re-usable, “plug‘n’play” test components that could be deployed in multiple unit tests designed to expedited the performance of repetitive test harness generation tasks), much less being available to pass along to testing.

In recent years, software test automation has been a major area of development in the discipline of software engineering. Tools for taking mundane, repetitive test routines and automating them have proven invaluable in freeing testers' time to focus on writing better, more comprehensive test suites, and improving the overall quality of the software quality assurance effort in many development organizations. However, as the level of sophistication of development environments continued to grow, the increasing demands placed upon software vendors to deliver high-quality systems quickly placed constraints on the level of automation that could be achieved. Automation, as a consequence, has been limited to mainly “black box” test purposes, since it is significantly more difficult to apply at the unit test level than it is to apply at the business process level familiar to most professional testers.

There have been numerous studies of the value of various test techniques to the overall level of quality of a piece of software. “Comparing and Combining Software Defect Detection Techniques: A Replicated Empirical Study” by Murray Wood et al, Proceedings of the 6th Annual European Conference Held Jointly with the 5th ACM SIGSOFT Symposium on Software Engineering, 1997, suggests that the key to higher quality is not so much in choosing one type of testing over another, but in combining various techniques. This study suggests that it is in combination that these techniques acquire a value “greater than the sum of their parts,” so to speak. This study did not anticipate the level or quality of blending of these test techniques envisioned, and delivered, by subject invention. The study merely assumed that both white and black box test techniques would be employed separately at various junctures in the lifecycle of the product's development.

One particularly well-known test methodology is Requirements-Based Testing (RBT). This rigorous methodology, as its name suggests, centers around the formal requirements as the key to proper system testing and at the core of this methodology are tools and techniques for deriving test cases from the formal statement of the requirements that go so far even as to validate that the statement of the requirements themselves are “correct”, that is, free of any ambiguity, circular logic, or untestable constraints/conditions.

The process of RBT involves constructing numerous Cause-Effect Graphs (CEGs) that describe, using a formal logical notation, the combination of events, inputs and system states that result in various expected behavior of the AUT. One significant issue for RBT that, in the prior art, was impossible to get around without some degree of methodological compromise, is the fact that invariably any non-trivial CEG would be composed of several “nodes” (which represent distinct states of specific system variables or events or conditions) that are simply not testable at the layer of the GUI. In other words, numerous functional requirements depend upon low-level, invisible states at some point in the CEG that cannot be confirmed and whose state must be assumed (or, in the terminology of one particular implementation of this methodology, “forced observable”). See, for example, StarBase's Caliber RBT, formerly of Technology Builders, Inc., and, before that, Bender & Associates. The industry-accepted statistic is that 56% of all defects have their origin in the requirements phase of the development process. The idea behind RBT is that by catching errors in the requirements before they become code is immensely valuable to a software organization, especially in light of the fact that the cost of fixing defects increases exponentially the further into the process a defect “migrates”. However, Caliber RBT does even more than that—it also calculates the minimal number of test cases to get complete coverage of all testable functional variations of the requirements, which is makes test case design and implementation much easier when it is an integral part of the early development effort. The effect of “forcing” (or pretending that one knows) an observable state is to suppress the number of testable functional variations across the CEG, which in turn reduces the number of test cases generated to obtain complete coverage of the requirements.

This was not a deception, but rather an honest limitation of the methodology, based on the fact that in the Prior Art there was no way to verify the state of those invisible nodes in the CEG at runtime.

The subject invention is specifically directed at removing this limitation. Targeted “probes” on specific functions or variables that implement a particular “forced observable” node in the CEG can be injected at runtime into the AUT during a test case derived from that CEG to obtain its actual state, meaning that it no longer need be “forced” observable and the number of testable functional variations need not be suppressed due to a limitation in the test data collection capabilities of the tester.

### SUMMARY OF THE INVENTION

The subject invention advances the blending concept to a new level by blending white and black box test techniques in the same tests. For instance, a test of a particularly critical business process—usually done at the “black box” level during integration testing prior to release—can also simultaneously verify the functional requirements of the application's behavior for that process, and verify various low-level requirements relating to memory usage, code coverage, optimization, and other metrics that are otherwise difficult or impossible to reliably obtain by any other means in that context. Correlations between business logic and low-level implementation code can be drawn that were impossible to detect in the prior art.

Moreover, this unique test component deployment architecture makes it possible to perform types of testing that have only been dreamed of in the prior art. For instance, one particularly easy task for a probe library as defined in the subject invention—deliberate fault injection to obtain coverage of exception handling that might otherwise go unexorcised (for lack of a means to induce a particular error condition “from the outside”)—is regarded in the prior art as nearly impossible to do in a consistent, repeatable, reliable fashion.

The subject invention fundamentally changes the dynamics of testing by providing developers first, but then also testers, with a methodology as well as a technology for building re-usable, plug‘n’play test components that simplify and expand the usefulness of both unit and general-purpose functional and integration test techniques.

The crux of the invention is the ability to deploy white box techniques via probe libraries in conjunction with functional test scripts much later in the product development and testing life-cycle than has previously been possible. The subject invention represents a fundamental departure in both technology and methodology from this particular aspect of the prior art, and improves the overall life-cycle development and testing process.

It is an important feature of the subject invention that probe libraries are created for enabling developers and testers to work both separately and together to obtain large quantities of data about the runtime behavior of the application under test (AUT), for a number of value-added debugging and test purposes.

For the developer, the probe libraries represent a means to validate that the implementation does in fact meet the specifications from which they developed their code. Probe libraries are also custom test tools that can be passed to testers to do some of the developer's legwork for them when a defect is detected by the test team. Probe libraries also can be used to test various theories of the root cause of unexpected, but not necessarily defective, behavior, and are a tremendous aid to overall software comprehension. Proofs of correctness are as important to the quality engineering aspect of the development life-cycle as are defect detection techniques, and in a healthy process the two go hand in hand. The subject invention provides a unique tool in the developer's toolbox in that it just as easily supports validation as it does defect detection.

For the tester, probe libraries are powerful tools that add tremendous capabilities to otherwise mundane test automation tasks. Not only can a tester automate a test of a particular business process using his favorite test automation tool, but he or she can also simultaneously gather low-level data that is otherwise inaccessible at the layer of the GUI, which means that the role of the tester can expand to include white as well as black box testing.

More importantly, the subject invention empowers testers with a powerful methodology representing a reliable safety net against low-level defects that might have made it past the developers. This in turn minimizes the likelihood of hard-to-detect defects actually migrating to the end-user in the final release.

The following is a summary of the benefits of the subject invention to the respective roles of developers and testers, and demonstrates how the methods and processes described herein revolutionize the life-cycle and development process.

Benefits to Developers

A clean alternative to littering source code with printf-style debugging and assertion code. Such code can be maintained separately and inserted in a transparent manner at points defined by the developer where necessary at runtime. For instance, one assertion probe can be applied generically to the entry point of many functions, as opposed to having to code the same code over and over again and recompiling the application every time a change to the logic of the assertion probe (after changing that logic in every place where it was coded!).

Re-usable unit test components that can aid in both correctness proof and defect detection. Probe libraries can maintain state information about the progress of testing at runtime. This information can be more easily managed in separate probe library code rather than intermingled in the source code of the application under test or the test harness of a particular unit of code. Test harnesses need not incorporate complex test logic, they can merely act as “dumb” harnesses, all the logic being in the re-usable probe libraries instead.

Simplified generation of custom test components that can be shared with testing during general functional, integration and regression testing, to aid in discovering the root cause of unexpected or erroneous application behavior in an integration test environment.

Radically reduced time and effort generating meaningful tests across subsequent iterations of the application under test (AUT).

Targeted debugging of specific suspected “sore spots” in the code (rather than having to filter out a lot of insignificant data generated by “mere” debuggers). Probes can be tactically or strategically targeted, whereas general purpose debuggers dump a lot of data and the developer has to spend time sifting through that data to the information he/she really needs.

Integration with other life-cycle technologies for requirements management, configuration management, testing and change management.

A complete test tool development environment to enable development organizations to easily build their own in-house test tools, rather than have to constantly review and learn new tools by third party vendors.

Benefits to Testers

The power to test non-functional aspects of low-level application performance or behavior, integrated with general purpose test automation tools, techniques and methods.

Ability to assess test metrics otherwise impossible to quantify (such as calculating the level of code coverage obtained by automated test suites ((vs. manual test suites)), and understanding the impact of automation test tool hooks in to the application on its overall performance and behavior).

Ability to aid the developer in a meaningful way in the process of debugging the AUT once a defect has been detected or suspected.

Ability to overcome custom object obstacles to test automation via probes in probe libraries, rather than having to ask development to recompile the application with test tool vendor-specific code added merely for test purposes.

Ability to apply otherwise difficult-to-implement test methodologies, such as Requirements-Based Testing (RBT) and fault injection.

Direct access-to-test test by-products of development, as well as to the developers themselves, as an aid in test case prioritization and automation.

The subject invention provides the first, general-purpose, truly “grey box methodology” test tool in the market, with broad implications for the future art of software development and testing.

Features of the invention that facilitate test technique blending include:

Customizable support for using black box, GUI and non-GUI record-replay script engines to drive probed applications in test cases.

An API for bi-directional interprocess communication between active probe libraries and external black box tools (in order to be able to facilitate targeted changes to the runtime state and behavior of probes and to facilitate synchronization and ultimate merging of output).

Other benefits include unique plug‘n’play test code delivery mechanism. More importantly the distributed platform architecture of the makes it possible to take advantage of this technology in a general purpose way for software testing and facilitates the improvement of existing and the evolution of new test methodologies, in addition to improving the software development and testing process through greater collaboration between developer and tester, ensuring higher software quality by blending test techniques.

The subject invention is architected from the ground up to be a test automation tool that works collaboratively with other test automation tools and life-cycle technologies. The underlying, general purpose patching engine that invention uses has no immediately evident test value, let alone test automation value. The invention is an automated test tool because it provides a purpose and a design to the process of test automation using this sophisticated technology that is lacking in the raw patching technology itself. In this regard, it is the first truly “grey box” test automation tool ever developed, since all other tools currently in the industry remain fixed to the prior art's paradigm of developers doing their own testing separate from the testers. In addition to developing reusable, plug‘n’play test components, the invention directly supports running automated test scripts against the AUT in test cases, and combining and collating the results of both the “black box” test script and the “white box” test probes deployed during a test run.

Features of the invention that directly promote integration with other test automation and other life-cycle technologies include:

Direct integration with industry-leading black box test automation technology from Mercury Interactive, particularly its TestSuite product line, including WinRunner and TestDirector.

General-purpose “Configure Tools” functionality that makes it possible to seamlessly integrate with other test automation and other life-cycle test technologies. These tools are placed in an MS Outlook-style navigation bar (called the “CorTEST NavBar”), published by CorTechs, Inc. of Centreville, Va., separated into logical categories representing the Requirements, Development, Configuration Management, and Testing phases of the software development lifecycle.

Direct integration with Software Configuration Management tools.

Additional tools to support unit and functional testing, particularly intelligent test case data and probe code generation.

### BRIEF DESCRIPTION OF THE DRAWINGS

FIG. 1 is a representation of an initial screen for creating a project in accordance with the teachings of the subject invention.

FIG. 2 is an exemplary screen for adding an executable target to the project.

FIG. 3 illustrates the screen with the new targets visible in the targets view window.

FIG. 4 is an exemplary screen showing the AUT (Application Under Test) inspector feature of the subject invention.

FIG. 5 is an exemplary screen showing the creation of a new Utility Probe Library.

FIG. 6 is an exemplary screen showing the creation of a new Custom C/C+ Probe Library.

FIG. 7 is an exemplary screen showing the new Probe Libraries in the Probe Libraries View.

FIG. 8 is an exemplary screen showing the Probe Library Runtime Configuration Tab.

FIG. 9 is an exemplary screen showing the addition of a new global option to a Probe Library.

FIG. 10 is an exemplary screen showing a default value for a global option.

FIG. 11 is an exemplary screen showing the addition of a keyword to a Utility Probe Library for mapping a function to a typeddef probe when a test case implementing this probe library is configured.

FIG. 12 is an exemplary screen showing the addition of parameters to a keyword in order to complete the mapping function.

FIG. 13 is an exemplary screen showing the addition of parameters to a keyword in a utility probe library, showing the default value as a blank.

FIG. 14 is an exemplary screen showing the function parameters.

FIG. 15 is an exemplary screen showing the editing source with build and output tabs for compiling/debugging.

FIG. 16 is an exemplary screen showing the function generator with easy access to the API and broken down by category with description, parameter completion and return type.

FIG. 17 is an exemplary screen showing the successful build of a probe library.

FIG. 18 is an exemplary screen showing the addition of a driver script to the project.

FIG. 19 is an exemplary screen showing the addition of a new test case to the project.

FIG. 20 is an exemplary screen showing the addition of another new test case to the project.

FIG. 21 is an exemplary screen showing the addition of yet another new test case to the project.

FIG. 22 is an exemplary screen showing the first step in including a probe library to a test case by “clicking on” the check box next to it in the probe libraries

FIG. 23 is an exemplary screen showing the predefined probe libraries as prefaced with a (P).

FIG. 24 is an exemplary screen showing the second step in adding a probe library to a test case by selecting its runtime configuration options.

FIG. 25 is an exemplary screen showing that each probe library provides a list of available global options and keywords that customize its runtime behavior on a pre-test case basis.

FIG. 26 is an exemplary screen showing that each option or keyword can have any number of customizable parameters for further refining the probe library's behavior at runtime on a per-test-case basis.

FIG. 27 is an exemplary screen showing the addition of a test set to a project.

FIG. 28 is an exemplary screen showing the addition of a test case to a test set.

FIG. 29 is an exemplary screen showing the synchronization of the execution of test cases in a test set based on dependencies, here showing the second test set case in the test site as being dependent upon the first to be completed before it will start.

FIG. 30 is an exemplary screen showing the controller ready for test execution.

FIG. 31 is an exemplary screen showing monitor, which here keeps track of multiple servers executing on multiple machines and on different operating systems, simultaneously.

FIG. 32 shows the server on WIN32.

FIG. 33 is an exemplary screen showing the controller after a test run.

FIG. 34 is an exemplary screen showing test results dialog highlighting the test run summary.

FIG. 35 is an exemplary screen showing test results dialog highlighting the summary of an individual test case within an executed test set during a test run.

FIG. 36 is an exemplary screen showing test results dialog highlighting the report of a test driver script that is brought into the results after the test run is complete.

FIG. 37 is an exemplary screen showing the test run results report generator for exporting the results to a preselected report generation program.

FIG. 38 is an exemplary screen showing a Word document with the test run results.

FIG. 39 is an exemplary screen showing the controller ready for the next regression run of the test case to verify the remediation of any discovered defects.

FIG. 40 (PRIOR ART) is a diagram showing the prior art software development life cycle.

FIG. 41 is a diagram of the software development life cycle in accordance with the subject invention.

### DETAILED DESCRIPTION OF THE PREFERRED EMBODIMENT

The invention is best understood by describing the development and testing process in connection with specific examples of the various features of the current embodiment of the invention that implement this process. The examples are for purpose of demonstration and are not intended to be in any way limiting of the scope and spirit of the invention.

Algorithms

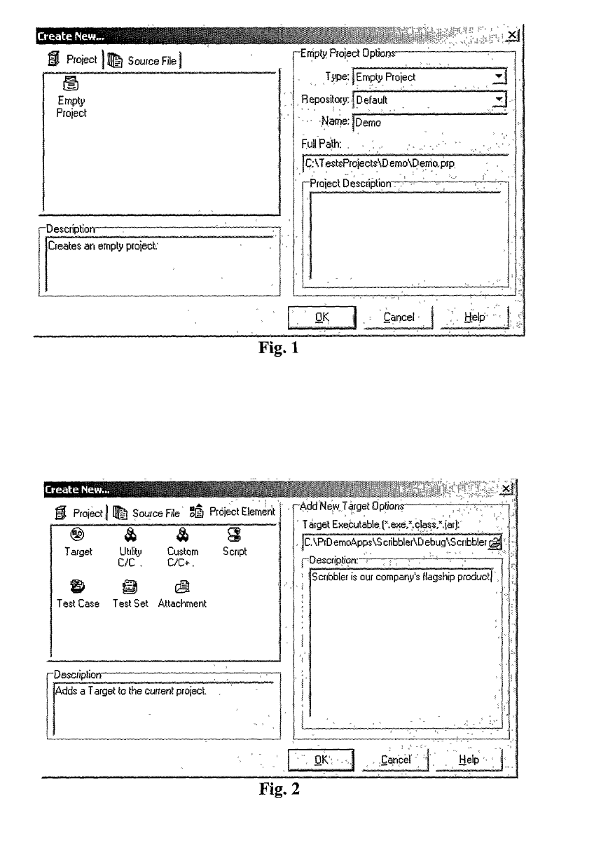

The unique combination of technological and methodological innovation significantly changes the software development and testing paradigm of accepting development organizations. The following describes the series of algorithms, or process, for iterative testing of software that is unique to development organizations that implement the process of the subject invention. An exemplary screen is shown in FIG. 1. (Primary roles for each step are indicated in brackets ([]).

I. Create a Project

a. [Admin] Select A Project Type (Alternatives vary according to edition)

b. [Admin] Select A Repository

c. [Admin] Provide a Name

d. [Admin] Provide a Description

e. [Admin] Add Users (Enterprise embodiment of the invention)

f. [Admin] If this project is to be linked to an external test repository (such as Mercury Interactive Test Director), then do so at this time.

II. Define Hosts (Enterprise Embodiment of the Invention)

a. [Admin] For each machine involved in distributed testing in the project:

i. Provide an IP address and port numbers for instances of the server on each.

ii. Provide a logical name for use in Scenarios

III. Define Targets

a. For each primary executable of the Application Under Test (AUT):

i. [Developer] Code the executable source.

ii. [Developer] Build the executable, ensuring that the executable contains full debug information.

iii. [Developer] If the executable to be tested is a DLL containing general-purpose API calls, then create or identify a “driver” executable that will be used to create the instance of the DLL required for testing.

iv. [Test Engineer] Locate the executable on the test machine by browsing to it.

v. [Test Engineer] Provide a description of the executable and its significance to the AUT.

vi. [Test Engineer] Add the executable to the project, see FIG. 2.

b. For each Target executable in the project:

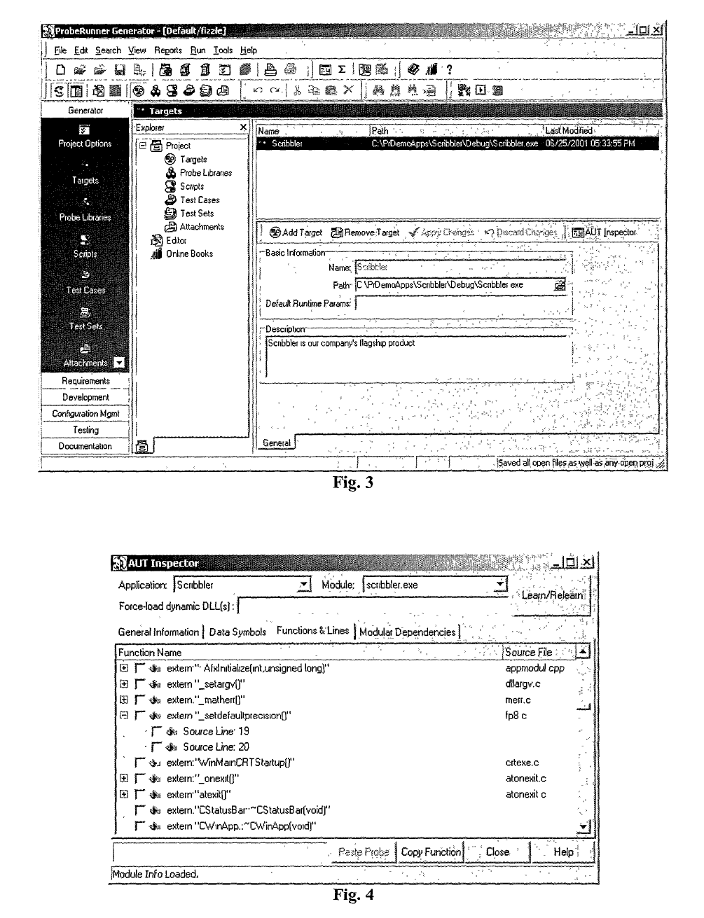

i. [Test Engineer] Once the executable is added (See FIG. 3), strip debug information into a local format suitable for an identical release of the executable that does not contain debug information. (This ensures that the same probes can be run against the production release of the executable, which ought not to contain debug information in order to protect the intellectual property of the application).

IV. Identify Valid Probe Entry Points

a. [Test Engineer and/or Developer] For each Target executable in the project:

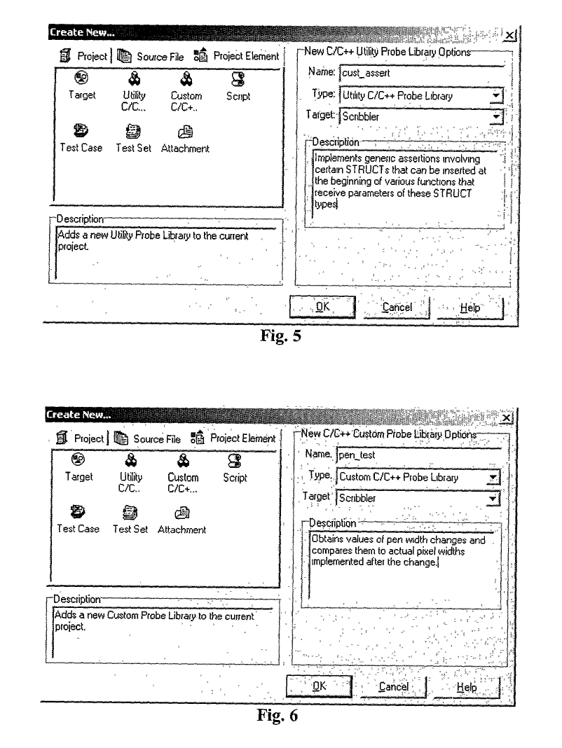

i. Invoke the “AUT Inspector,” a tool built into system of the subject invention for obtaining information about instrumentable data, functions and source lines (See FIG. 4).

ii. Indicate any DLL's that are dynamically loaded during execution so that they can be force loaded by the AUT inspector and added to the list of modules. (Only DLLs with statically linked functions in the executable are detected by default.)

iii. Select “Learn AUT”.

iv. This information is stored persistently in *.aut files, one per module that comprises the executable.

v. Note that some functions and source lines are not instrumentable (as indicated by a yellow arrow icon, as opposed to a green arrow icon) before writing any probes on those functions and source lines.

vi. [Developer] Verify debug information. If debug information is absent or incorrect (for instance, source line numbers do not match actual source file layout), then check the debug settings and ensure that they are correct for that development environment (varies).

With specific reference to FIG. 4, note Modular Dependencies in the AUT Inspector. These help narrow the list of potentially significant functions from external DLLs used by the executable, as it notes the statically linked functions from those DLLs that appear in the import table of the executable, and any cross dependencies among those DLLs that may indicate fruitful trace configurations. Note also the arrow near extern:“WinMainCRTStartup( )” indicating that this function should not be instrumented. Note also that any instrumentable source lines in an instrumentable function are indicated, as well as source file information, whenever available.

V. Create Probe Libraries for Use Against Targets

a. [Developer, or Test Engineer with Developer collaboration] For each probe library to be generated:

i. Use a Predefined Probe Library where appropriate instead of creating a new one from scratch. These are, in the standard embodiment of the invention, as follows (subsequent embodiments will add to this list):

1. function tracing=>PrTrace

2. function profiling=>PrProfile

3. code coverage=>PrCoverage

4. memory analysis=>PrMemWatch

ii. Identify specific legitimate probe need/justification.

Examples:

1. information gathering or correctness proof

2. behavior visualization

3. unit testing

4. debugging

5. fault injection

6. requirements-based testing (non-functional, low-level tests of conditions not observable at the layer of the GUI)

7. collating test metrics

iii. Identify high-level probe test constraints and variable considerations:

1. maximum permissible overhead/impact

2. level of intrusion required/tolerable

3. efficiency goals

4. target-specific constraints or considerations

a. programming language (C, C++, etc.)

b. instrumentability of functions to be probed

c. interaction with other executables, especially in multithreaded applications.

5. interprocess communication needs, if any

6. impact of other tools used during testing (driver scripts, for example)

iv. Decide on Probe Library type (types below describe the current embodiment of the invention; subsequent types are under development, particularly for Java, which will be broken out differently in a manner to be described in future addendums to this application):

1. Select Utility (or dynamic) Probe Library:

a. Where probe requirements are sufficiently generic and the variables are sufficiently predictable to be abstracted into a “typedef” probe that can be used against any function, or any function of a particular applicable category across multiple executables.

b. Where re-use is especially important and feasible, particularly when creating general purpose test utilities (Predefined Probe Libraries mentioned above in V.i.a.1 are examples of this kind of probe library).

2. Select Custom (or static) Probe Library

a. When probe requirements are unique and specific to a particular function in a particular module.

b. When test need is narrow, as in the case of debugging a particular defect, or proving the correctness of an algorithm implemented in a specific module, or obtaining the conformance of specific low-level implementation code to requirements.

c. When performance constraints are only obtainable by taking advantage of compile-time binding of probes to their target functions, data or source lines in the executable to which they are instrumented.

v. If the probe library is to be of type “Utility”, then implement the following planning steps:

1. Identify “typedef” probes to be deployed with the Utility Probe Library.

2. For each “typedef” probe to be created:

a. Define test-case specific input variables that may be needed for the probe to be instrumented correctly

i. Define probe library-level variables that set specific limitations or options about how the probe should behave at runtime and/or how the data is to be formatted postruntime. These might be options defining “modes” of operation, such as:

1. debug (or verbose output)

2. update (generate expected results)

3. verify (compare actual to expected results)

ii. Define typedef probe-level variables that affect the instrumentation rules of each function instrumented with typedef probes in this Utility Probe Library.

b. Define a keyword that can “mark” a specific function in the configuration file as a target function to be instrumented using this typedef probe.

c. Define all parameters to the keyword that affect how a given function is instrumented or help resolve potential symbol name conflicts across modules.

vi. Else if the probe library is to be of type “Custom”, then implement the following planning steps:

1. Define any and all probe library-level variable inputs (such as mode of execution, as described above).

2. For each function to be instrumented with a probe:

a. Determine a name for the probe, if one is required (for instance, to dynamically enable/disable the probe)

b. Determine any on_entry actions to be taken, including, but not limited to:

i. Deferencing of runtime parameters passed to the function.

ii. Logging of entry time and the state of any data elements at entry.

iii. Modification of the values of runtime parameters passed to the function.

iv. Other, such as:

1. Conditional enabling/disabling of named probes

2. Interprocess communication with probes in another probed executable or external test tools.

c. Determine any on_line entry points, that is, probes on specific source lines in the function or subprogram being probed, and the appropriate actions to be taken at those points in the course of execution.

vii. Define the input parameters appropriate to the probe library based upon the planning steps implemented (above).

viii. Define program-level on_entry behavior, as appropriate. Typical uses of program-level entry points are:

1. Obtain test-case-specific runtime and format-time parameters from a configuration file.

2. to initialize probe-related data.

3. Disable probes that are to be triggered by some specific event or condition.

4. to make socket connections or establish other means of interprocess communications with other probed executables or other test tools that may wish to interactively exchange data with the probe library at runtime.

5. Dynamic instrumentation of the probed functions (as is necessary when the probe library is of type “Utility”)

ix. Define program-level on_exit behavior, as appropriate. Typical uses of program-level exit points are:

1. free any allocated memory that may not be freed yet

2. close socket connections or halt other means of interprocess communication.

x. Define thread-level on_entry behavior, as appropriate. Typical uses of thread-level entry points are:

1. Initialization of thread-scoped variables

2. Logging of the time of creation and other details about the new thread.

3. Enabling/Disabling of named probes, as appropriate.

4. Dynamic instrumentation of probed functions (as is necessary if the probe library is of type “Utility”).

xi. Define thread-level on_exit behavior, as appropriate. Typical uses of thread-level exit points are:

1. Freeing of allocated thread-scoped variables that might not be freed yet and are no longer needed.

2. Logging of the state of the thread at exit.

3. Enabling/Disabling named probes, as appropriate.

xii. Define format-time on_entry behavior, as appropriate. In the current embodiment of the invention, there is a distinction between runtime, and post-run format-time execution. In order to minimize the impact of data collection at runtime, data can be logged to an intermediate form that can be formatted post-runtime. Typical uses of format-time entry points are similar to those for program-level entry points, except they usually apply solely to rules governing how the logged data is to be extracted and formatted in a human readable-form. Most of this is automatic if the user employs log ( . . . ) and log ( . . . ) with <function> syntax of the current implementation. Another use of format-time entry points distinct from program-level entry points is to print out a report header or summary of results, before the raw data is displayed in the body of the probe library's format-time logic.

xiii. Define format-time on_exit behavior, as appropriate. These are similar to program-level exit points, except that they may optionally be used to generate report footer information on exit from the application at format-time.

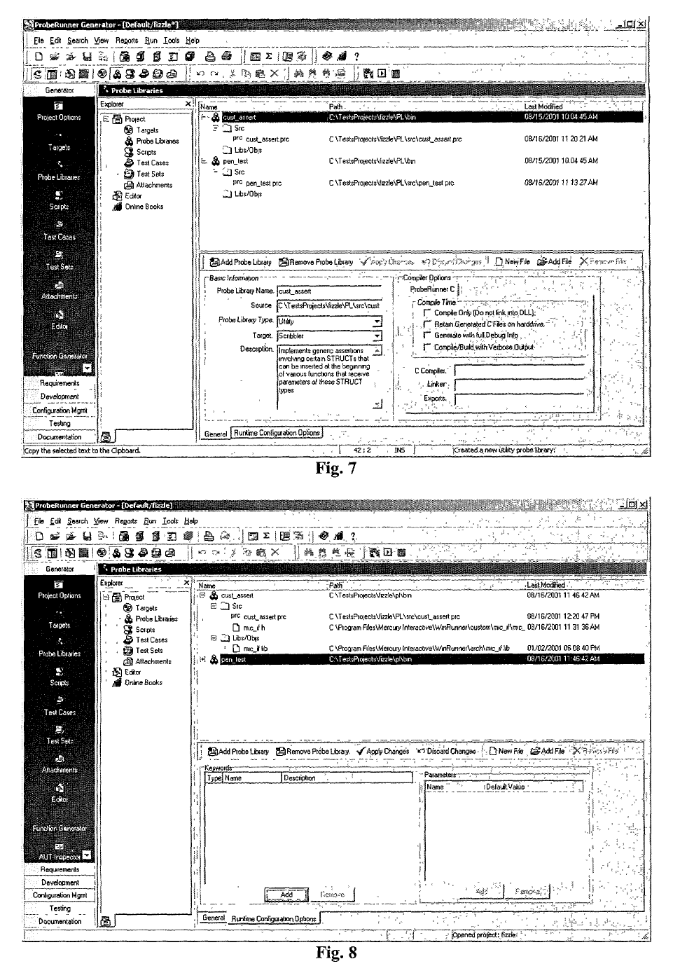

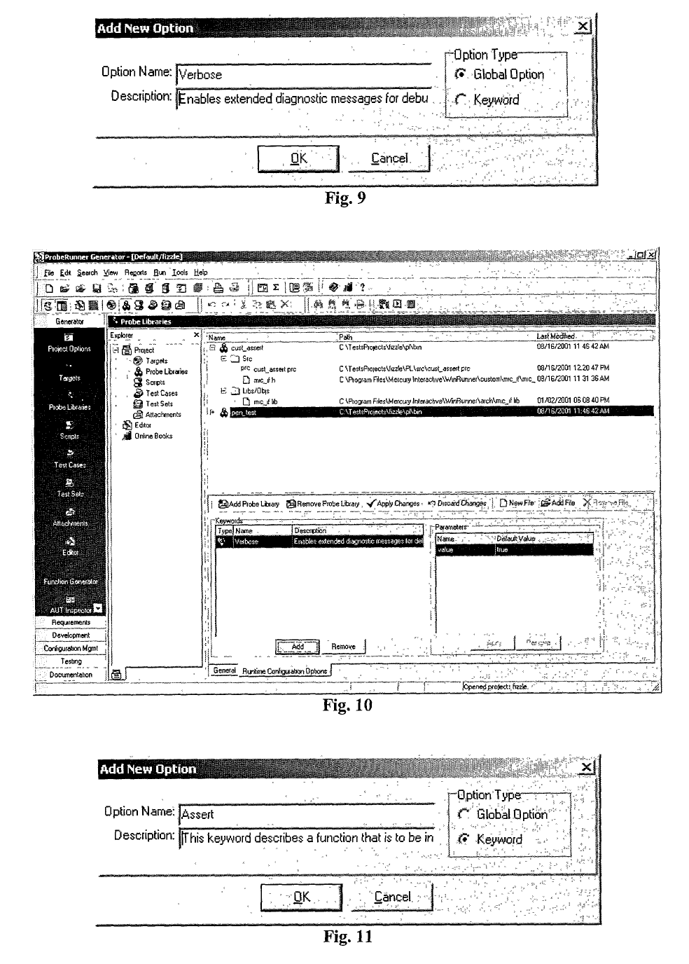

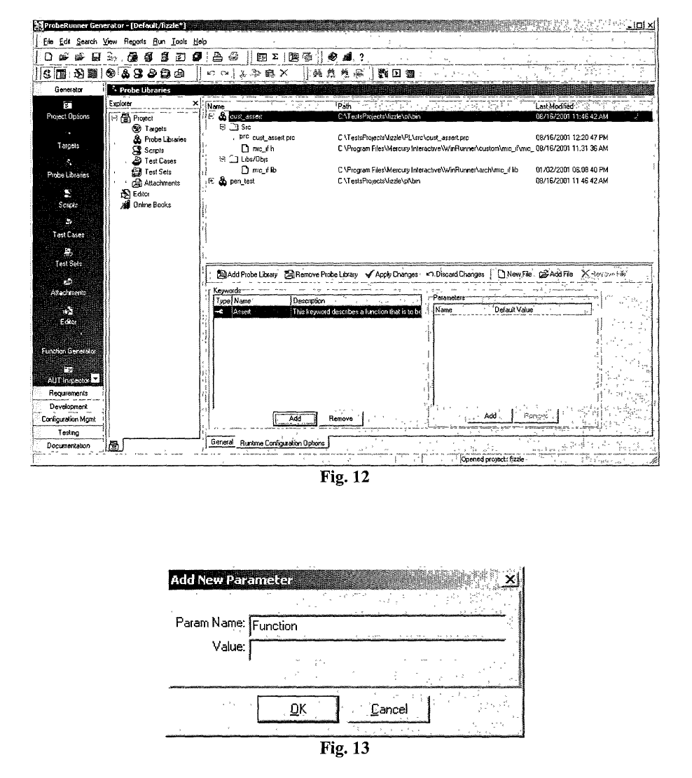

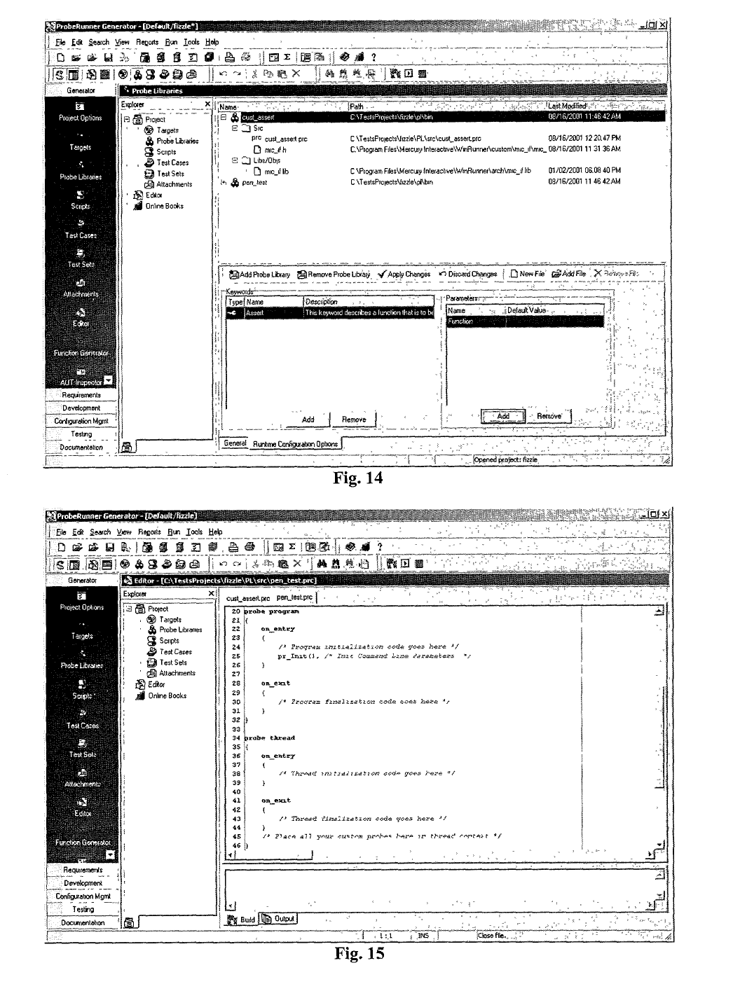

xiv. Create the Probe Library Object in the Project (See FIGS. 5, 6 and 7).

1. Select a logical name for the probe library.

2. Select a type (based on requirements).

3. Select a target from the list of available Project Targets.

4. Provide a description of the Probe Library, its purpose and any other important information about it.

xv. Set initial/default compiler and linker options.

xvi. Specify any exported symbols.

xvii. Add any static libraries or object files to be compiled with the probe library.

xxiii. Define the Runtime Configuration Options for the Probe Library. (See FIG. 8). Note that these are used by the Test Cases View to configure the probe library for use in a specific test. Note that in the described embodiment of the invention, this does not automatically generate support code for these options—these will have to be implemented by the Probe Library author. However, it is within the scope and spirit of the invention that the system will generate and regenerate the necessary support code.

xix. Implement the Probe Library in predefined language (typically native language) per specifications developed during the planning stages of probe library development.

1. If the probe library is of type “Custom”, be sure to implement all compile-time function probes in the probe thread context, separate from thread-level on_entry and on_exit blocks but within the probe thread block.

2. Assure that any interfaces defined during the planning stages for runtime options and/or exported symbols are indeed implemented as defined in the Probe Library's PRC source code (See FIG. 15). In the current embodiment of the invention, it is possible to define certain probe library user-defined functions as “exported,” meaning that if another probe library merely includes its header file, it can call these functions at runtime as it could any other API. Advanced applications of this technique involve the deployment of multiple probe libraries in a single run, where each probe library acts as an agent and can alter the runtime state of any (other) exposed probe library via its exported interface, depending upon the needs of the test, which the consumer probe libraries must have sufficient built-in logic/intelligence to determine at runtime. This technique of deploying “probe agents” using this feature of the current embodiment of the invention is described in a separate white paper, “Deploying Intelligent Test Agents in Distributed Systems”. The preferred embodiment of the invention will auto-generate much of the “housekeeping” code where runtime configuration parameters are involved, as well as perform precompilation analysis to alert to the users to any conflicts or implementation omissions.

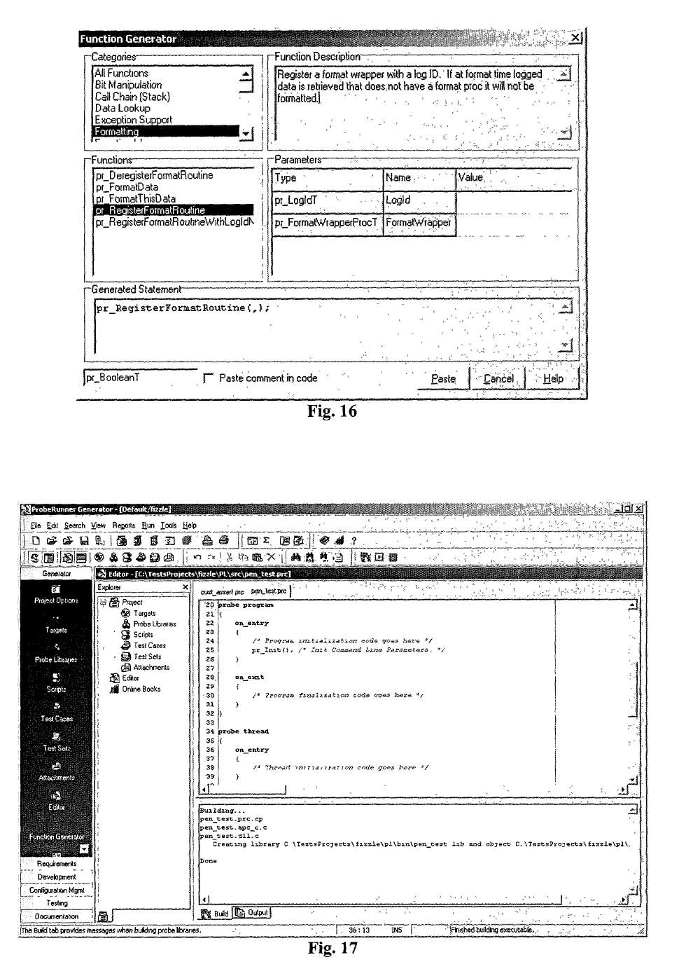

3. Use the Function Generator to implement syntactically correct calls to the Probe API, a large collection of utility functions to facilitate common probe tasks (See FIG. 16).

xx. Compile and Build the Probe Library (See FIG. 17).

1. Select appropriate compiler and linker options.

2. Build. If Build results window indicates errors or warnings, then repeat the process after all errors and warnings are addressed and the probe library compiles and links without errors or warnings.

xxii. Debug/Test the Probe Library.

1. If the Probe Library is of type “Custom”, then:

a. If the Probe Library does not require any configuration parameters to be passed to it at runtime, then simply “Run” immediately after compiling the probe library. Runtime output will be displayed in the Output window.

b. Else if the Probe Library requires configuration parameters, then a test case will need to be created for the purpose of testing the probe library.

c. (Suggested) Optionally run output validation scripts on the text output, especially if there is a large quantity of data generated. Such validation scripts should be able to determine expected output from configuration and test case file information.

2. If the Probe Library is of type “Utility”, then:

a. Create several test cases each with different executables and configuration parameters to thoroughly exercise your utility probe library and all its functionality.

b. (Suggested) Optionally execute output validation scripts, especially if the quantity and variety of data generated is large.

3. It is advisable to implement a Debug/Verbose mode in every probe at a minimum, such that when the probe library is executed in that mode, information about the behavior of the probe library at runtime is generated.

VI. Add Driver Scripts to the Project

a. [Test Engineer] Give the script a logical name for the Project.

b. [Test Engineer] Select the type of Script. The available types are configurable using the “Configure Tools” utility.

c. [Test Engineer] Browse to the path of the script.

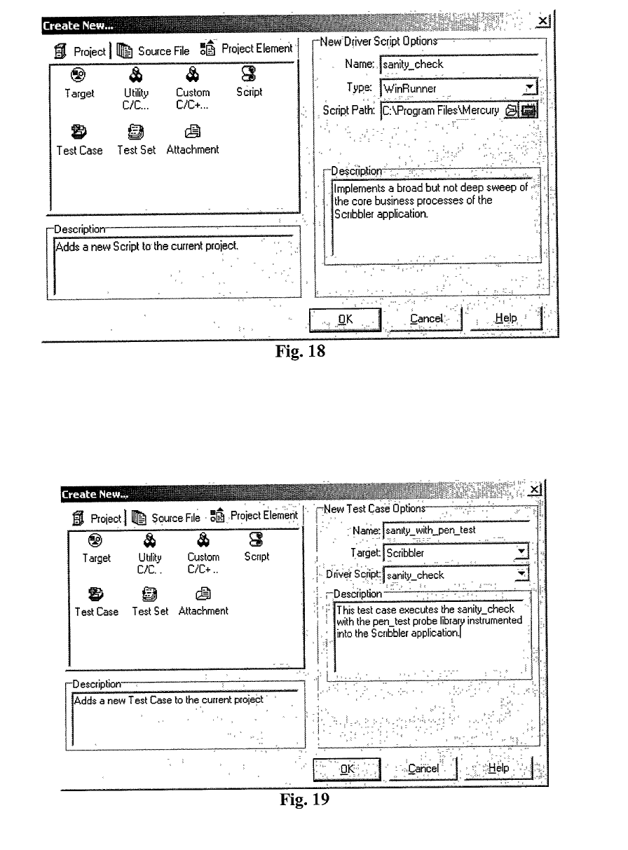

d. [Test Engineer] Provide a description of the script, its purpose in the project (See FIG. 18).

VII. Define and Generate Test Cases (Enterprise)

a. [Developer] If the purpose of the test case is to implement or facilitate a unit test:

i. Use the Test Case Generator in Unit Test Mode to compose a state model for the class/unit under test.

ii. Link the source code to the state model.

iii. Compile the state model. This will generate a test harness and a two probe libraries (one against the test harness module, and one against the functions in the source file of the class/unit under test), and add both to the project as a Target and Probe Libraries, respectively. It will also create a comma separated list of test data values and expected results and add that to the list of parameters passed to the test harness.

iv. Create a Test Case using the Probe Library against the Target (test harness).

a. [Test Engineer] If the purpose of the test case is to implement a test during functional, integration or regression testing:

i. Use the Test Case Generator in Functional Test Mode to compose a cause-effect graph based on the requirements of the business process or system function under test.

ii. Compile the cause-effect graph. This will generate the necessary test case specifications and add them as a document attachment to the project.

iii. For each generated test case specification:

1. Write a driver Script using a supported script tool that implements the test case as specified.

2. Consult with developers regarding existing or needed probe libraries to test low-level functionality related to invisible nodes in the cause-effect graph and add them to the project.

3. Add the corresponding Script and Probe Libraries to the Test Case. Be sure to set any configuration parameters required by each probe library correctly.

c. [Developer or Test Engineer] Add the Test Case to a Test Set, and the Test Set to a Scenario.

d. [Developer or Test Engineer] Execute the Scenario.

e. [Developer or Test Engineer] Analyze the results.

VII. Create Test Cases

a. [Developer and/or Test Engineer] Plan the Test Case

i. For each test case to be added to the project:

1. Decide on the specific test objectives of the test case.

2. Identify the target.

3. Identify a driver script that provides the external sequence of actions that trigger the desired internal behavior that one which to test.

4. If no such script exists, create it, and add it to the project.

5. Identify all probe libraries and specific configuration options for each that provide the desire probative functionality.

6. If specific needs are not met by existing probe libraries or configuration options, then either add the desired probative functionality/capability to existing probe libraries, or create a new probe library that does provide this capability, and add it to the project.

b. [Test Engineer] Implement the Test Case.

i. For each Test Case to be added to the Project:

1. Select a meaningful name for the test case.

2. Select the target.

3. Select the driver script to provide the necessary external actions.

4. Provide a meaningful description of the purpose of the test case.

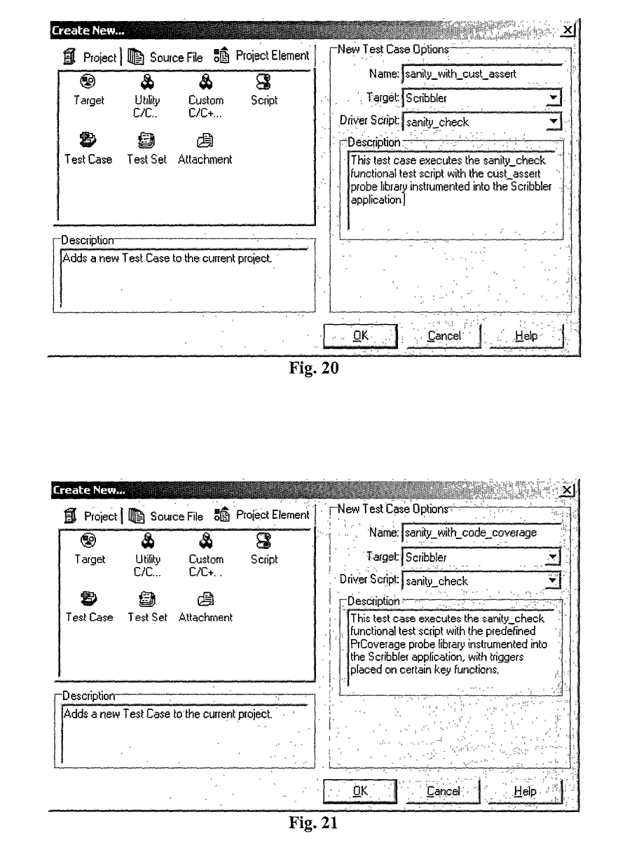

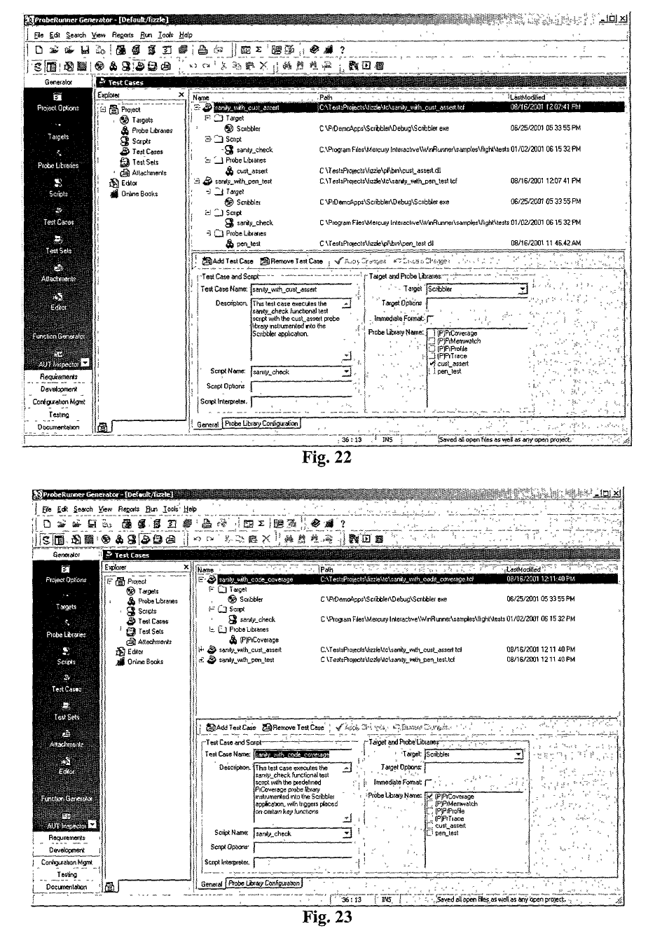

5. Add the test case to the project (See FIGS. 19, 20 and 21).

6. Add optional parameters to the driver script for this test case, if any.

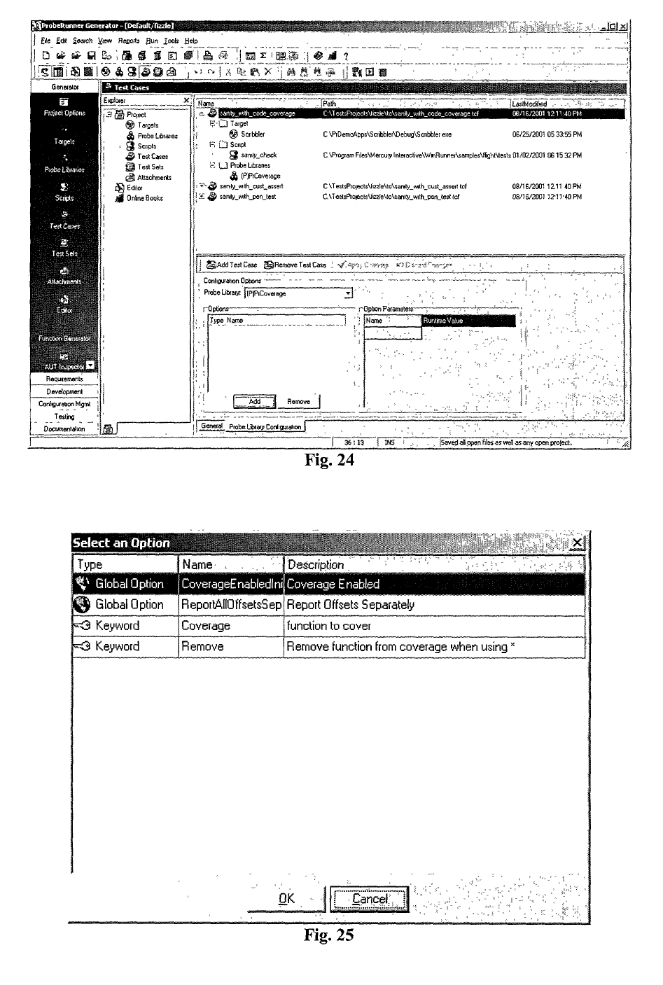

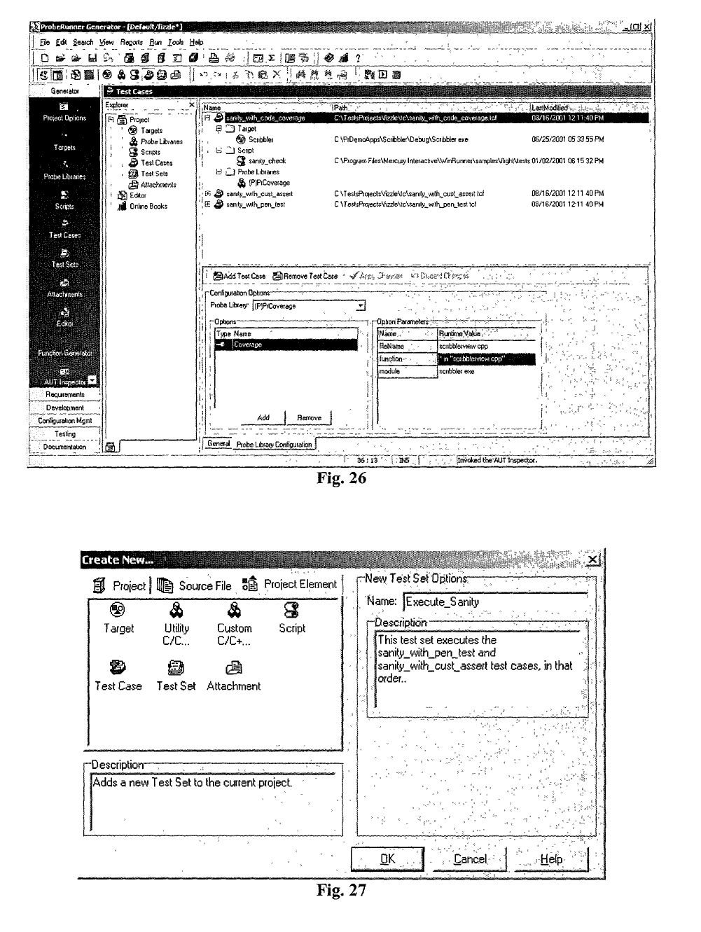

7. For each Probe Library to be added to the Test Case (See FIGS. 22-26):

a. Click the checkbox next to it in the list of available probe libraries.

b. Add desired configuration options and parameters to the probe library for this Test Case.

IX Combine Test Cases into Test Sets

a. [Test Engineer] Plan the Test Set.

i. Identify Related Test Cases. For instance, if the application involves more than one executable simultaneously executing, then a Test Set might implement one Test Case on one of the executables, and (an)other(s) on the other(s).

ii. Determine if there are any dependencies. For instance, one use of a Test Set might be to execute a sequence of similar Test Cases. In this case, it makes sense to order them in some fashion that is conducive to the overall purpose of the Test Set.

b. [Test Engineer] Implement the Test Set.

i. Provide a meaningful name for the Test Set.

ii. Provide a meaningful description of the Test Set.

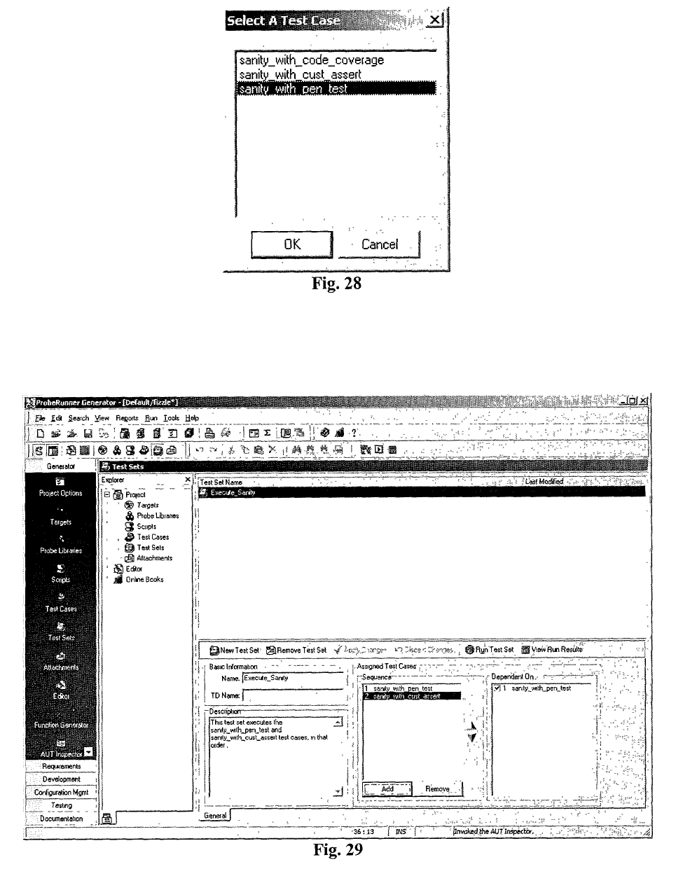

iii. Add Test Cases to the Test Set (See FIGS. 27 and 28).

iv. Synchronize the Test Cases, if necessary (See FIG. 29), based on any inherent dependencies between them. In the Enterprise embodiment of the invention, conditional dependencies and execution branching will be supported in Test Sets.

X. Combine Test Sets into Scenarios (Enterprise)

a. [Test Engineer] Plan the Scenario.

i. Identify the Hosts on which the Scenario will be executed.

ii. Identify the Test Sets to be executed.

iii. Identify specifically which Test Sets need to be executed in which sequence on which hosts, and any dependencies between Test Sets executed across all Hosts.

b. [Test Engineer] Implement the Scenario.

i. Add Hosts to the Scenario.

ii. Add Test Sets to the Scenario.

iii. Link Scenarios and Hosts, as appropriate.

iv. Establish Synchronization rules for Test Sets on each Host.

v. Establish Dependencies for Test Sets to be executed simultaneously on different Hosts (to ensure that the proper tests are executed on a client and on the server at the right times).

vi. Schedule a Test Run.

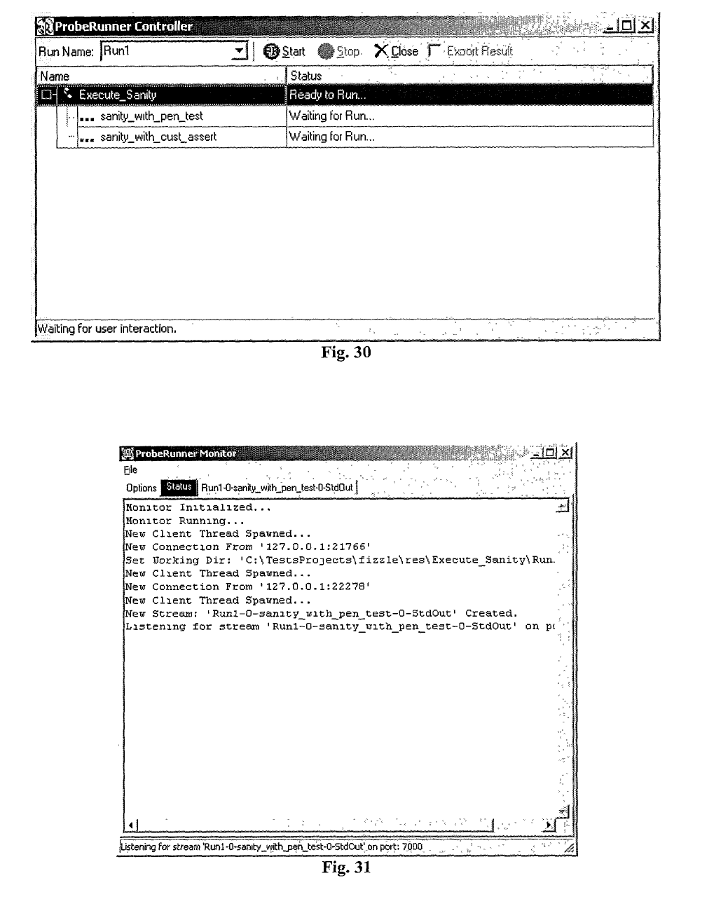

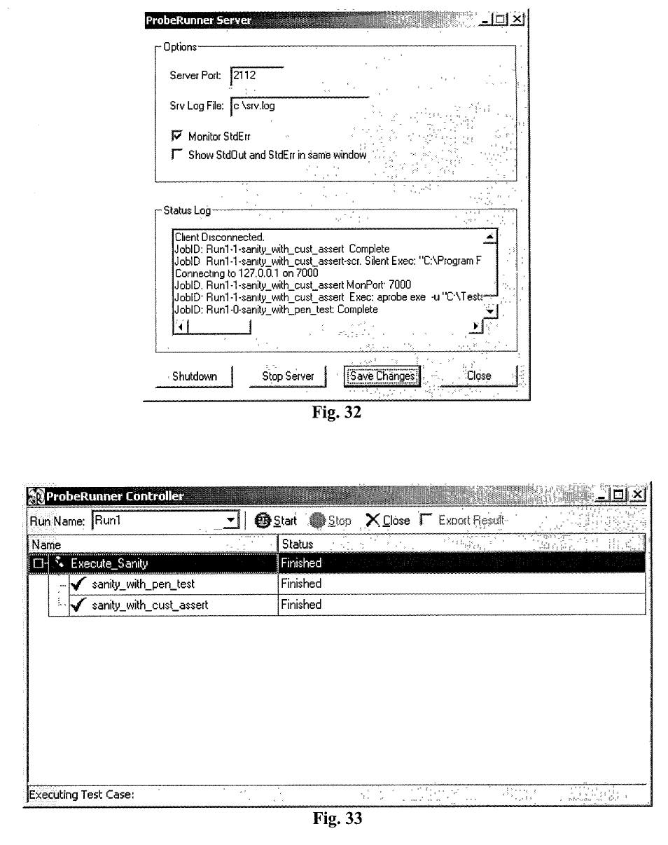

XI. Run Tests (See FIGS. 30-33)

a. [Test Engineer] Invoke the Controller.

b. [Test Engineer] Ensure that the execution tree is properly sequenced and the dependencies are set they way they ought to be.

c. [Test Engineer] Select “Start” to invoke the Monitor and Server and initiate the test run. If certain test cases are manual in nature, be prepared to provide the necessary external user actions to drive the test as appropriate, and close the application as necessary to trigger the next Test Case/Test Set.

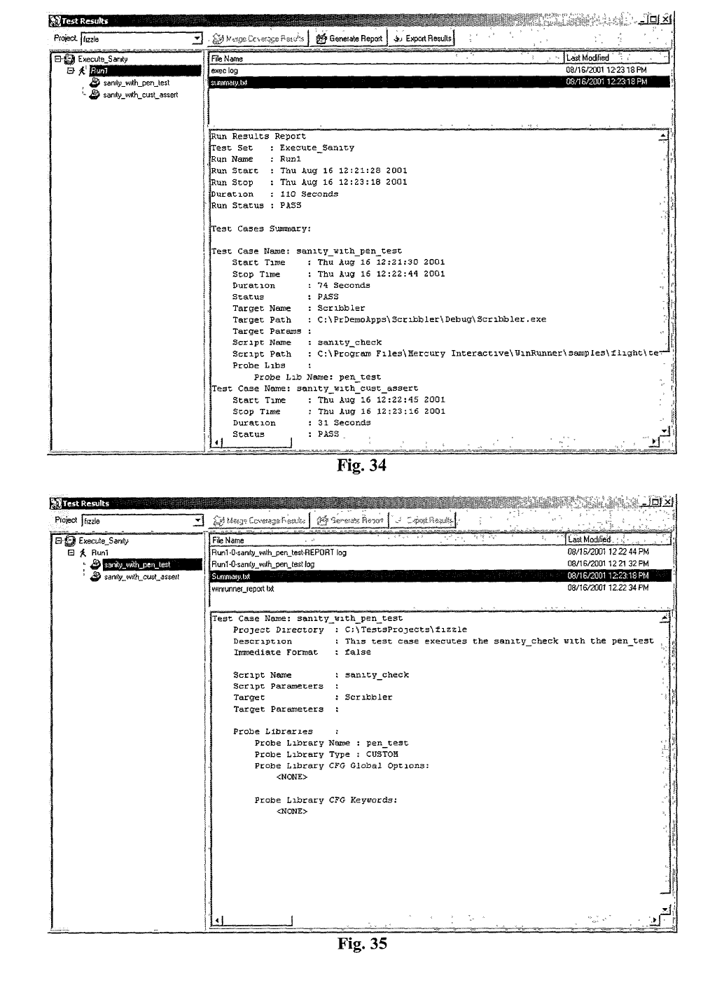

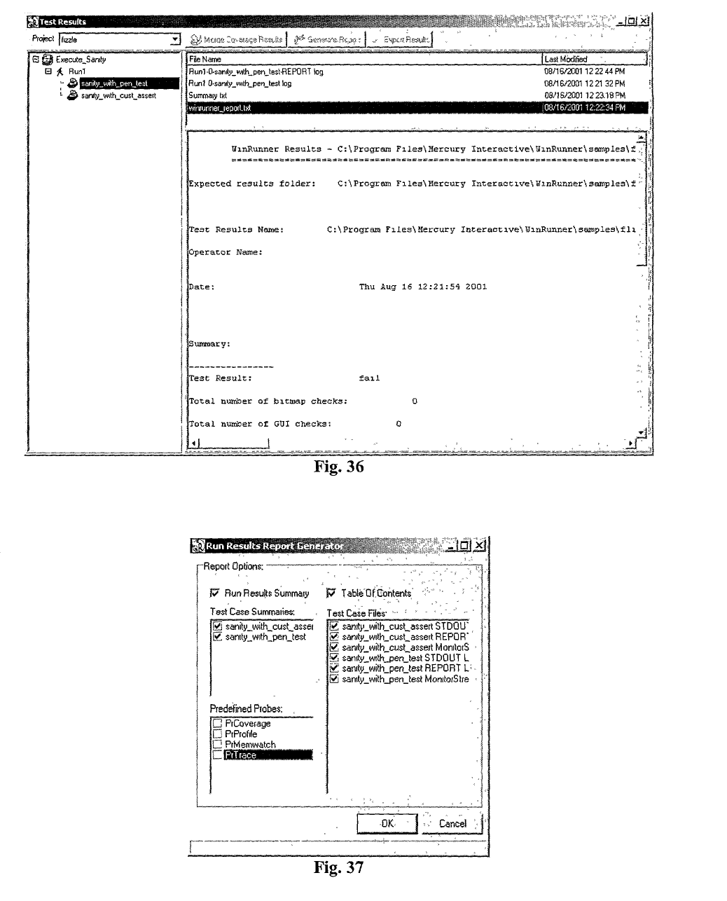

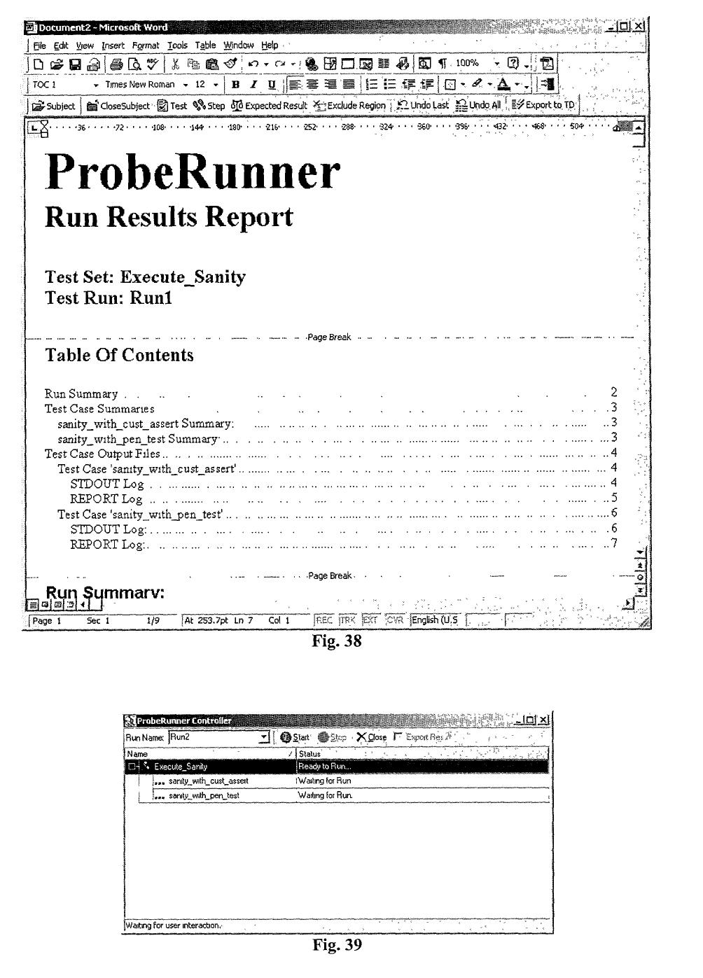

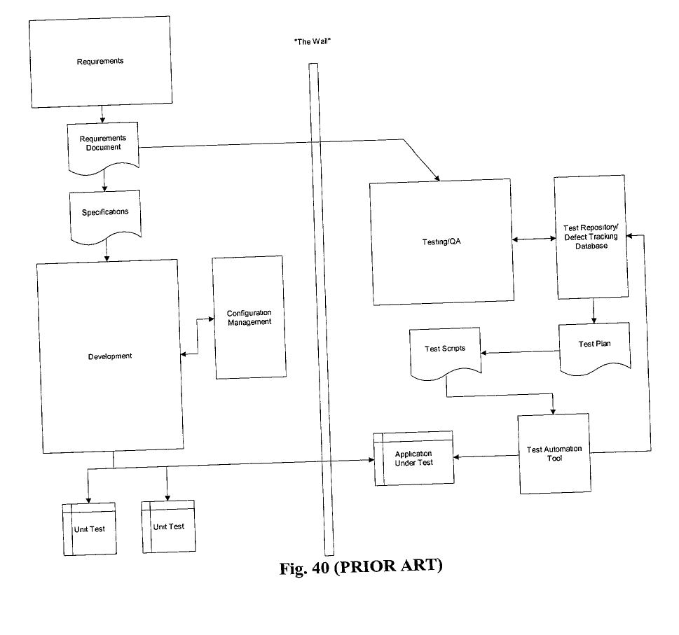

XII. Analyze Results (See FIG. 34-38)

a. [Test Engineer and Developer] Scan the results for failures.

b. [Test Engineer and Developer] Generate a Test Run Report.

c. [Test Engineer and Developer] Ascertain whether detected defects are in fact defects, and add them to the Defect Tracking Database.

d. [Developer] If the cause is not obvious, generate probe libraries and test cases as necessary to test various theories of the root cause of the defect.

e. [Developer] Remediate the defect.

XIII. Rerun Tests

a. [Test Engineer] Upon notification of the remediation of a discovered defect:

i. Relearn the application under test and all its affected target executables that may have been rebuilt.

ii. Examine existing custom probe libraries for potential conflicts with changed internals of the application under test.

iii. Rerun the test case that originally uncovered the defect to ensure that it is no longer present (See FIG. 39).

iv. If the Developer added probe libraries to the project to uncover the root cause of the defect, check with the developer to ascertain whether any of them might be useful to incorporate into the Test Case (or justify creating a new Test Case).

The Role of The Invention in the Software Development Lifecycle

FIG. 40 (PRIOR ART) illustrates the Software Development Lifecycle in the prior art. Note that in the prior art, there are significant gaps in the process. One of the most obvious is the lack of any real link between developer unit tests and functional/regression tests developed by test engineers. In fact, note that developers are often working from detailed specifications, whereas testers are often working from very high level functional requirements. There is an implicit assumption that the specifications correctly implement the requirements, and no way for testers to verify the implementation at the code level during general QA—it is just assumed that the results of unit tests carry over to tests in general integration testing, an assumption that is tenuous at best. Also, note that there is no real integration between the configuration management system used by developers and the test management system used by the testers (if any!). All of these gaps represent significant “opportunities” for defects to migrate directly past QA and into the laps of the end-users.

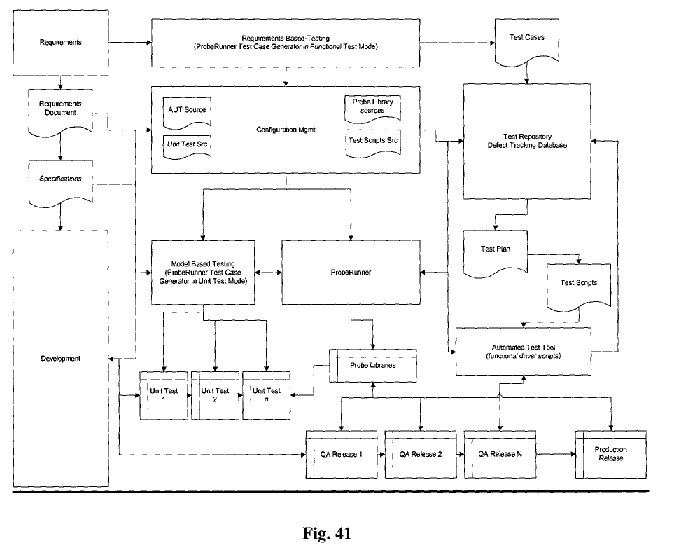

Compare this to the diagram of FIG. 41, which depicts the process of the subject invention. The process of the subject invention directly addresses all of these issues. With specific reference to FIG. 41 and as contrasted with the PRIOR ART diagram of FIG. 40, it will be noted that a “wall” exists between the development side (on the left) and the testing side (on the right). In both cases the development process will start with Requirements from which a Requirements Document is produced. From this, the Specifications are generated and the Development cycle is commenced. As shown in FIG. 40 (PRIOR ART), configuration management tools will be used to manage the development cycle. Unit tests are performed during the development cycle. The approved software and requirements documentation are then “thrown over the wall” to the quality assurance team, where testing takes place with errors and defects noted and “thrown back over the wall” to development for correction.

By way of contrast, it will be noted that the “wall” does not exist under the development cycle of the subject invention as shown in FIG. 41. Significantly, the discrete and isolated Testing Quality Assurance function has been replaced by interactive steps including Requirements Based Testing, the development of Test Cases, Model Based Testing, the generation of custom and reusable “plug‘n’play” probe libraries and reiterative testing, communication, modification and release of iteratively modified releases, ultimately providing a comprehensively tested product for release. It is an important aspect of the subject invention that the Requirements Based Testing communicates with the Configuration Management even during the Requirements Document phase and the Specifications phase. This assures that the Probe Libraries, Test Scripts and Unit Test criteria will be in compliance with the Requirements from the beginning of the process and permits the development of accurate and useful test cases. This further enhances the development of useful Model Based Testing and Unit Tests. In operation, as an application under test (AUT) is released by development, the Requirements Based Testing and Model Based Testing will generate useful information for the developers to refine the AUT as required. It is an important part of the invention that the Tester will have at his/her disposal Probe Libraries that are both generic and customized for the AUT. This permits the tester to provide meaningful Model Based Testing and to develop iterative unit tests as the product is released in iterative releases.

While certain features and embodiments have been described in detail herein, it should be understood that the invention includes all enhancements and modifications within the scope and spirit of the following claims.

What is claimed is:

1. A method for merging white box and black box testing of software applications during and after the development phase, comprising the steps of:
a. analyzing the performance of an application to determine functionality prior to release;
b. performing a black box test on the application;
c. simulating white box test conditions during black box testing.

2. The method of claim 1, wherein the simulating step comprises patching a command line in the source code of the application to bypass an error.

3. The method of claim 1, wherein the performing step occurs during development of the application and simultaneously with white box testing.

4. The method of claim 3, further comprising an iterative step of updating the white box test in response to black box test analysis and updating the black box test in response to white black test analysis.

5. The method of claim 1, further comprising the step of generating probe libraries in response to test analysis.

6. The method of claim 5, wherein said probe libraries contain white test probes.

7. The method of claim 5, wherein said probe libraries contain black test probes.

8. The method of claim 5, wherein said probe libraries contain reusable test probes.

9. The method of claim 1, wherein steps a, b and c are performed in combination with white box testing.

10. The method of claim 1, wherein steps a, b and c are performed independently of white box testing.

11. A method for iterative testing of software during the development cycle by communicating between development and testing phases for defining a grey box test regimen, comprising the steps of:
a. providing a requirements document to a development phase and a testing phase;
b. generating a test case based on the requirements document;
c. utilizing plug‘n’play probes to test the software;
d. communicating errors and deficiencies to the development cycle based on performance under the test case using the probes.

12. The method of claim 11, wherein the probes are saved in a library for reuse.

13. The method of claim 12, wherein the probes are generic and may be utilized with a plurality of software systems.

14. The method of claim 12, including the step of customizing the probes for use in connection with the testing of a particular software system.

15. A method for iterative testing of software applications during development, comprising the steps of:
a. creating a test project by selecting a program to be tested;
b. selecting a repository for the program;
c. defining a target for each primary executable of the program;
d. stripping debug information into a local format;
e. identifying probe entry points in the program;
f. creating a probe library for use against the target;
g. adding driver scripts;
h. defining and generating a test case;
i. creating a test case;
j. combining the test case into a test set;
k. running the test in accordance with the test case and test set;
l. analyzing the results;
m. repeating the test.

16. The method of claim 15, further including the step of generating a report.

17. The method of claim 15, further including the step of adding additional users after step b.

18. The method of claim 15, further including the step of linking to an external test repository after step b.

19. The method of claim 15, step d further including the step of stripping debugging information into a local format.

20. The method of claim 15, step e further including the steps of:
a. indicating DLLs;
b. verifying debug information;
c. noting modular dependencies.

21. The method of claim 15, step f further including the step of using an available probe library.

22. The method of claim 15, step f further including the step of creating an custom probe library.

23. The method of claim 21, wherein the selected probe library is a utility probe library.

24. The method of claim 23, including the additional steps of:
a. identifying typdef probes to be deployed with the utility probe library;
b. defining the typdef probe-level variables that affect instrument at rules of each function instrumented.

25. The method of claim 16, including the additional steps of:
a. defining all probe library-level variable inputs;
b. defining inpout parameters appropriate to the probe library.
